(19) United States
(12) Patent Application Publication
(10) Pub. No.: US 2007/0176586 A1
(43) Pub. Date: Aug. 2, 2007

(54) Mobile device for powering, recharging and/or controlling a height-fixed electric appliance

(76) Inventors: Michel Lecomte, Nantes (FR); Marc Pichon, Brest (FR)

Correspondence Address: EGBERT LAW OFFICES, 412 MAIN STREET, 7TH FLOOR, HOUSTON, TX, 77002, US

(21) Appl. No.: 10/552,751

(22) PCT Filed: Apr. 13, 2004
(86) PCT No.: PCT/FR04/50157

§ 371 Date: Dec. 14, 2006

(30) Foreign Application Priority Data
Apr. 11, 2003 (FR) 0304522

(51) Int. Cl. G05F 1/00

(52) U.S. Cl. 323/283

(57) ABSTRACT

The mobile device for powering, recharging and/or controlling a height-fixed electric appliance includes a first connection structure which can co-operate with a second connection structure, belonging to an electrically-operating appliance. The first connection structure is disposed at the end of a stick or similar element, housing a linking means which connects the first connection structure to the control device, disposed at the other end of the stick or similar element.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a device for powering, recharging and/or controlling a height-fixed electrically operating appliance.

Such a device will find a particular, non-restrictive application in the field of billboard advertising, and more exactly for hanging billboards which have to be frequently and/or periodically replaced.

These hanging billboards are mainly used in exhibition halls, stores and other buildings with large surfaces and large ceiling height, for spreading advertisements and the like. Now, the messages to be spread regularly change and it is therefore necessary to replace the billboard one by one.

### BACKGROUND OF THE INVENTION

The simplest billboard-carrying devices are comprised of a billboard-carrying profile capable of maintaining an edge of the billboard, and hung from wire members. The replacement of such a billboard requires using equipment such as a ladder, with the risks of falling this represents for the user, in particular when the billboard is placed in a very high position and/or when the latter is of a large size.

In order to cope with these risks, there have been provided mechanical devices, such as the one described in FR 2.676.299, which are comprised of winders capable of allowing the winding up and the unwinding of the wire members, so as to bring the billboard-carrying profile at breast height, authorizing an easy replacement of the billboard.

Though these devices represented a great progress from the point of view of safety, other disadvantages have arisen, in particular as regards their operation.

Thus there have been provided devices such as those described in WO 97/46993, FR 2.773.412 and FR 2.828.322, which contemplate to trigger the operation through a remote control allowing actuating the device remotely. These devices do however not solve the energy-supply problems, and there should be provided a fixed power-supply installation, which highly limits the places capable of being equipped with billboards.

It should be noted that there has been contemplated to use rechargeable accumulators, for example through photovoltaic cells, however with drawbacks from the point of view of reliability.

From U.S. Pat. No. 6,327,803 is also known a billboard-carrying device, including a cable winder the winding-up shaft of which is provided with a coaxial crown wheel with which is aimed at co-operating, through engagement, a rotationally driven pinion carried at the end of a pole. The operator can thus, through remotely coupling the pinion with the toothed wheel, and through controlling the rotation of said pinion in one direction or in another one, activate the winding-up or the unwinding of the cables.

This device has however drawbacks for remotely maintaining the pinion coupled with the toothed crown wheel, knowing that the unwinder is mobile.

### BRIEF SUMMARY OF THE INVENTION

The purpose of the present invention is to provide a device for powering, recharging and/or controlling a height-fixed electrically operating appliance, which allows coping with the various above-mentioned drawbacks.

According to the invention, the device for powering, recharging and/or controlling a height-fixed electrically operating appliance is characterized in that it includes first connecting means capable of co-operating with second connecting means said electrically operating appliance comprises, said first connecting means being arranged at the end of a pole or the like containing linking means connecting said first connecting means to control means arranged at the other end of said pole or the like.

According to an additional feature of the device according to the invention, the control means include an electric-energy source, which electric energy is capable of being transmitted, through the connecting means of the pole, the first connecting means and the second connecting means, to the electrically operating appliance, for putting the latter into operation.

According to another additional feature of the device according to the invention, the electric-energy source is associated with switching means capable of allowing reversing its polarity at the level of the first connecting means.

According to another additional feature of the device according to the invention, the electric-energy source is associated with means capable of causing the intensity of the transmitted current to vary.

According to another additional feature of the device according to the invention, the pole or the like is designed of a varying length.

According to another additional feature of the device according to the invention, the first and the second connecting means have a shape allowing them to be used to hang up the pole.

According to a particular embodiment of the device according to the invention, the first connecting means are in the form of two substantially elastic lead wires, which are widening and each have a hook-like shape, while the second connecting means are also in the form of two lead wires, which are widening and each have a fold aimed at receiving the hook of one of said wires forming the first connecting means.

The device according to the invention has many advantages compared to the known devices, it namely allows an installation at any place whatsoever without requiring any special equipment, such as a power supply.

The advantages and features of the device according to the invention will become more obvious from the following description which refers to the attached drawing, which represents a non-restrictive embodiment of same.

### BRIEF DESCRIPTION OF THE SEVERAL VIEWS OF THE DRAWINGS

FIG. 1 shows a perspective view of a device for powering, recharging and/or controlling a height-fixed electrically operating appliance according to the invention.

FIG. 2 shows a perspective view of a portion of the same device in use.

### DETAILED DESCRIPTION OF THE INVENTION

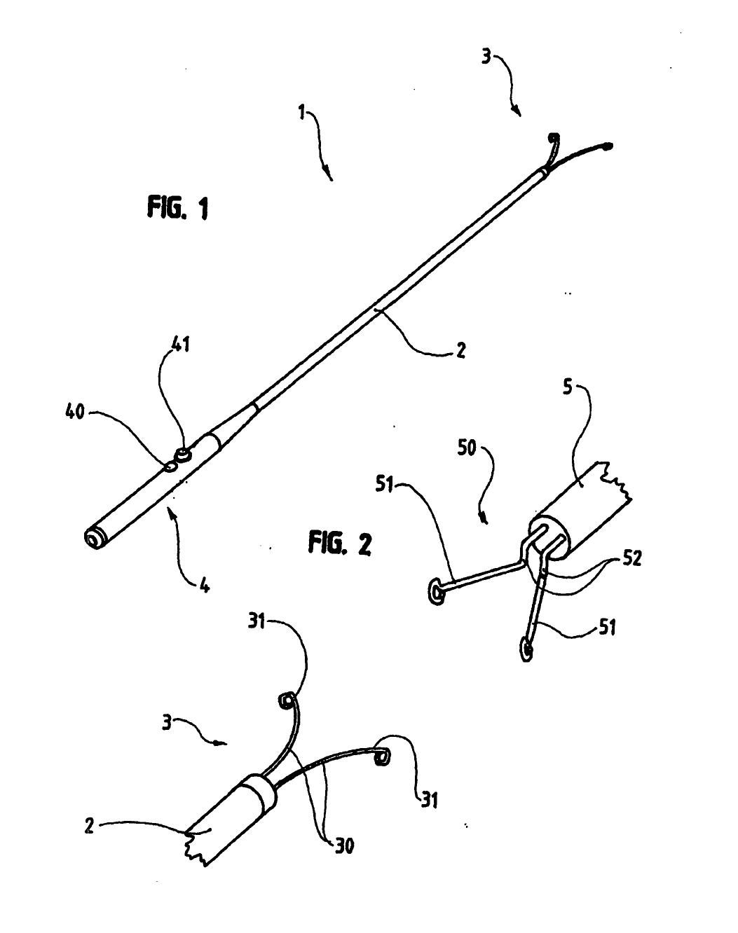

When referring to FIG. 1, one can see that a device 1 for powering, recharging and/or controlling a height-fixed electrically operating appliance is in the general form of a pole including an elongated body 2 provided, at one end, with contact means 3, which will be described hereafter, and, at the other end, with a casing 4 containing control means, not shown.

The body 2 is crossed by conducting members, not shown, capable of connecting the control means to the contact means 3.

The device according to the invention can be in a form according to various embodiments, which essentially differ from each other as to the control means the casing 4 contains.

In the preferred application of the actuation of a billboard carrier, the control means consist in transfer or restitution means for the electric energy to be supplied to the contact means 3. These means can thus consist in a simple socket-outlet aimed at being connected to the network, but they preferably consist on accumulators.

The casing 4 is provided with means, such as button 40 and switch 41, allowing to control the release of energy and, for example, to reverse the polarity of the contact means 3, and/or to vary the intensity, and thus to act on the operation of the electrically operating appliance.

It should be noted that the elongated body 2 is preferably designed of a varying length, it can thus either be telescopic or be comprised of reversibly butt-joined members.

When referring now to FIG. 2, one can see the contact means 3 of the device 1, as well as part of a height-fixed electrically operating appliance 5 aimed at being powered, recharged and/or controlled by the device 1.

The contact means 3 are comprised of two wire 30 made out of a conducting material, for example copper, which protrude with respect to the end of body 2 while widening, while maintaining a certain elasticity, and the ends of which 31 have a hook-like shape.

The appliance 5 includes contact means 50 aimed at co-operating with the contact means 3, and which include two wires 51 made out of a conducting material such as copper, which are preferably protruding with respect to an end of the appliance 5, while widening, while maintaining a certain elasticity.

The wires 51 are, in the vicinity of their connection to the appliance 5, substantially folded at right angles, so as to create for each one of the wires 30 an anchoring area 52, which will be defined below; it should be noted in this respect that the two anchoring areas 52 are separated from each other by a distance smaller than that which separates both hook-like ends 31 of the contact means 3.

It will be understood that bringing the contact means 3 into co-operation with the contact means 5 occurs through nearing the wires 30 closer to the wires 51, through inserting the wires 30 between the wires 51 until hook-like ends 31 are blocked in the anchoring areas 52, the elasticity of the wires 30 and 51 allowing to increase the contact and thus to ensure the passing through of the current.

It should be noted that the hooks that form the ends 31 of the wires 30 can have an additional functionality; they can indeed allow to hang up the device according to the invention, and preferably on hanging-up means having for example, but not exclusively, the characteristics of the contact means 5, and supplied with electric energy in order to recharge the accumulators contained in the casing 4.

We claim:

1. Device for powering, recharging and/or controlling a height-fixed electrically operating appliance, said device comprising:
a first connecting means co-operating with a second connecting means of the electrically operating appliance, said first connecting means being arranged at an end of a pole containing a linking means connecting said first connecting means to a control means arranged at another end of said pole.

2. Device according to claim 1, wherein said control means is comprised of an electric-energy source, electric energy being transmitted, through the connecting means of the pole, first connecting means and said second connecting means, to the electrically operating appliance, for putting the electrically operating appliance into operation.

3. Device according to claim 2, wherein said electric-energy source is associated with a switching means allowing reversal of polarity thereof at a level of said first connecting means.

4. Device according to claim 2, wherein said electric-energy source is associated with variation means causing intensity of transmitted current to vary.

5. Device according to claim 1, wherein said pole is formed of a varying length.

6. Device according to claim 5, wherein said pole is comprised of reversibly butt-joined members.

7. Device according to claim 1, wherein said first connecting means and said second connecting means have a shape allowing the connection means to be used to hang up said pole.

8. Device according to claim 1, wherein said first connecting means are formed of two substantially elastic lead wires, widening and each having a hook-like shape, second connecting means being formed of two lead wires, widening and each having a fold aimed at receiving a hook of one of the wires forming said first connecting means.
